(19) United States
(12) Patent Application Publication
(10) Pub. No.: US 2017/0251735 A1
(43) Pub. Date: Sep. 7, 2017

(54) MULTIFUNCTIONAL FABRIC, FABRICATING METHOD THEREOF AND OUTDOOR GARMENT

(71) Applicants: Boe Technology Group Co., Ltd., Beijing (CN); Beijing Boe Optoelectronics Technology Co., Ltd., Beijing (CN)

(72) Inventors: Yanna Xue, Beijing (CN); Shijun Wang, Beijing (CN); Zhenhua Lv, Beijing (CN); Yong Zhang, Beijing (CN); Wenbo Jiang, Beijing (CN); Lei Mi, Beijing (CN); Wenjun Xiao, Beijing (CN); Kaixuan Wang, Beijing (CN); Yue Li, Beijing (CN)

(21) Appl. No.: 15/216,793

(22) Filed: Jul. 22, 2016

(30) Foreign Application Priority Data
Mar. 3, 2016 (CN) 201610120950.7

(51) Int. Cl. A41D 13/01; B32B 27/20; D04H 13/00; B32B 5/02; A41D 31/02; B29B 11/12; B29C 55/12; B29C 53/32; A41D 13/00; B32B 27/32; B29B 7/08

(52) U.S. Cl. CPC A41D 13/01; B32B 27/322; B32B 27/20; D04H 13/00; B32B 5/022; B29B 7/08; B29B 11/12; B29C 55/12; B29C 53/32; A41D 13/0015; A41D 31/02; B32B 2264/102; B32B 2437/00; B29K 2027/18

(57) ABSTRACT

A multifunctional fabric, a fabricating method thereof and an outdoor garment are described. The multifunctional fabric comprises: a PTFE microporous membrane; wherein the PTFE microporous membrane is added with an inorganic nano luminescent material. In this way, after the fabric is made into garments, particularly when it is applied in outdoor sports garments, the inorganic nano luminescent material can absorb UV rays to make the garments glow, thereby not only improving aesthetics of the garments, but also reducing damage of the UV rays to human health. In addition, by adding the inorganic nano luminescent material in the PTFE microporous membrane, the problems of poor firmness and persistence of a single PTFE material can be overcome. Because the molecular bond of the inorganic nano luminescent material has high intensity and is stable, the multifunctional fabric will be durable after it is added with the inorganic nano luminescent material.

### RELATED APPLICATIONS

The present application claims the benefit of Chinese Patent Application No. 201610120950.7, filed on Mar. 3, 2016, the entire disclosure of which is incorporated herein by reference.

### FIELD

This disclosure relates to the technical field of fabric, particularly to a multifunctional fabric, a fabricating method and an outdoor garment.

### BACKGROUND

Outdoor sport is one way of entertaining, relaxing and exercising for people. With the increasing life stress nowadays and the promotion of people's life quality, more and more people begin to perform outdoor sport. In order to perform outdoor sport more comfortably, outdoor sports apparel has become more and more important. Existing outdoor sports apparel can generally realize the breathable and waterproof function, but it has relatively single style and color and is not durable. Moreover, when people perform outdoor sport, the strong UV rays may easily cause damage to people's health.

### SUMMARY

According to a first aspect of this disclosure, a multifunctional fabric is provided, comprising: a PTFE microporous membrane; wherein the PTFE microporous membrane is added with an inorganic nano luminescent material.

In an embodiment, the inorganic nano luminescent material is one of a red powder material, a green powder material, a blue powder material or any combination thereof.

In an embodiment, the red powder material is Y₂O₃:Eu.

In an embodiment, the green powder material is CeMgAl₁₁O₁₉:Tb.

In an embodiment, the blue powder material is BaMgAl₁₀O₁₇:Eu.

In an embodiment, the diameter of a micropore of the PTFE microporous membrane is 0.1-0.5 microns.

According to a second aspect of this disclosure, a method for fabricating the above multifunctional fabric is provided, comprising:

mixing a PTFE raw material, an inorganic nano luminescent material powder and a hyperdispersant through ultrasonic vibration;

pre-pressing the mixed liquid into a workblank and calendaring it into a slice;

two-way stretching, pre-shaping and coiling the slice.

According to a third aspect of this disclosure, an outdoor garment is provide, which is fabricated using the above multifunctional fabric.

In an embodiment, the above outdoor garment may comprise: a surface layer, a multifunctional layer and an inner layer; wherein the surface layer and the multifunctional layer are fabricated using the multifunctional fabric; the inner layer is arranged for protecting the surface layer and the multifunctional layer.

By adding the inorganic nano luminescent material in the multifunctional fabric provided above, after the fabric is made into garments, particularly when it is applied in outdoor sports garments, the inorganic nano luminescent material can absorb UV rays to make the garments glow, thereby not only improving aesthetics of the garments, but also reducing damage of the UV rays to human health. In addition, by adding the inorganic nano luminescent material in the PTFE microporous membrane, the problems of poor firmness and persistence of a single PTFE material can be overcome. Because the molecular bond of the inorganic nano luminescent material has high intensity and is stable, the multifunctional fabric will be durable after it is added with the inorganic nano luminescent material.

### BRIEF DESCRIPTION OF THE DRAWINGS

In the drawings:

FIG. 1 is a flow chart of a method for fabricating a multifunctional fabric according to an embodiment of this disclosure;

FIG. 2 is a structural schematic view of an outdoor garment according to an embodiment of this disclosure.

### DETAILED DESCRIPTION

Next, embodiments of this disclosure will be explained in detail with reference to the drawings.

According to an embodiment of this disclosure, a multifunctional fabric is provided, comprising: a PTFE (polytetrafluoroethylene) microporous membrane; wherein the PTFE microporous membrane is added with an inorganic nano luminescent material.

The multifunctional fabric provided by the embodiment of this disclosure is added with an inorganic nano luminescent material. In this way, after the fabric is made into garments, particularly when it is applied in outdoor sports garments, the inorganic nano luminescent material can absorb UV rays to make the garments glow, thereby not only improving aesthetics of the garments, but also reducing damage of the UV rays to human health. In addition, by adding the inorganic nano luminescent material in the PTFE microporous membrane, the problems of poor firmness and persistence of a single PTFE material can be overcome. Because the molecular bond of the inorganic nano luminescent material has high intensity and is stable, the multifunctional fabric will be durable after it is added with the inorganic nano luminescent material.

In an embodiment, the inorganic nano luminescent material is one of a red powder material, a green powder material, a blue powder material or any combination thereof. The multifunctional fabric can emit light of different colors through different ratios of the inorganic nano luminescent materials of three colors including red, green and blue. For example, when only the red powder nano luminescent material is added, the multifunctional fabric can absorb UV rays so as to emit red light; when the three inorganic nano luminescent materials of red, green, and blue are added according to a certain proportion (e.g. red:green:blue=3:6:1), the fabric can absorb UV rays so as to emit white light.

In an embodiment, the red powder material can be europium activated yttrium oxide, and the chemical formula thereof is Y₂O₃:Eu. Optionally, other red fluorescent powder materials can also be used, e.g. Y₂O₂S:Eu³⁺, CaSiN₂:Eu²⁺.

In an embodiment, the green powder material can be Cerium terbium activated magnesium aluminate, and the chemical formula thereof is CeMgAl₁₁O₁₉:Tb. Optionally, other green fluorescent powder materials can also be used, e.g. BaN₂S₄:Eu²⁺; Sr₃SiO₅:Eu²⁺; CaSi₂O₂N₂:Eu²⁺.

In an embodiment, the blue powder material can be europium activated barium aluminate, and the chemical formula thereof is BaMgAl₁₀O₁₇:Eu. Optionally, other blue fluorescent powder materials can also be used, e.g. CaLaGa₃S₆O:Ce³⁺; SrAl₂Si₂O₃:Eu²⁺; Ba₂Si₅N₈:Ce³⁺.

In an embodiment, the diameter of a micropore of the PTFE microporous membrane is 0.1-0.5 microns. Generally, the diameter of the water vapor molecule is 0.0004 microns, the diameter of the minimum mist in rain water is 20 microns, and the diameter of drizzle is up to 400 microns, hence, the diameter of the micropore of the PTFE microporous membrane of the multifunctional fabric provided by the embodiments of this disclosure is between those of the water vapor and the rain water, i.e., the diameter of the micropore is less than that of the minimum mist in the water molecule and far greater than that of the water vapor molecule, thus the water vapor can pass through the PTFE microporous membrane while the water drop cannot, thereby being capable of achieving excellent waterproof and breathable function. In addition, because the micropores of the PTFE microporous membrane are extremely small, and are arranged in zigzag irregularly in the longitudinal direction, the wind cannot penetrate the PTFE microporous membrane, thereby achieving the effects of being windproof and keeping warm and so on.

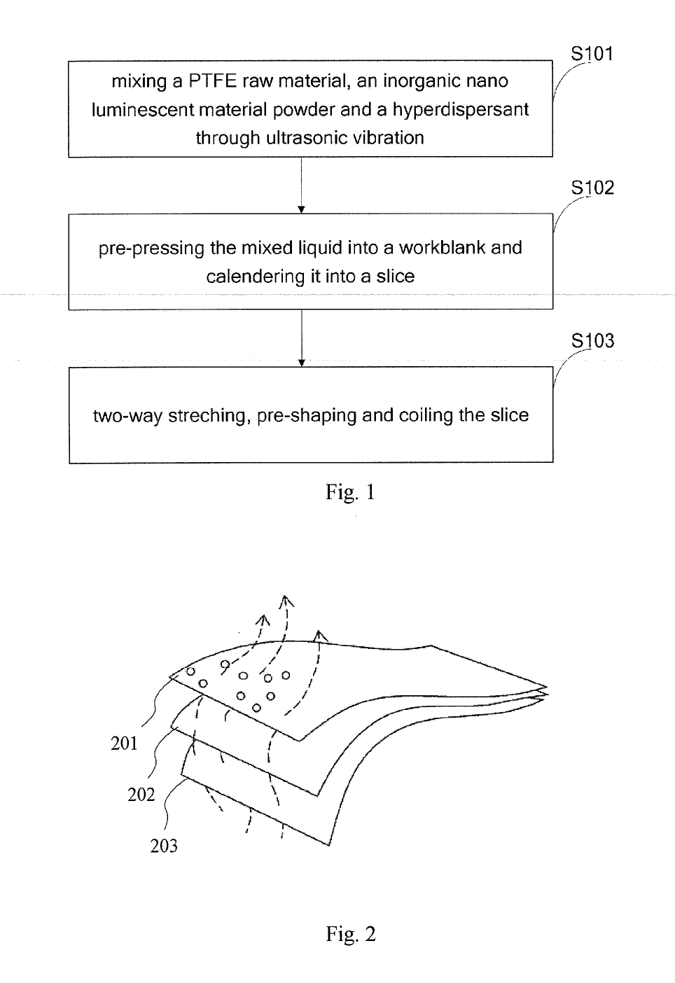

Based on the same inventive concept, an embodiment of this disclosure provides a method for fabricating the above multifunctional fabric. As shown in FIG. 1, the method may comprise:

S101: mixing a PTFE raw material, an inorganic nano luminescent material powder and a hyperdispersant through ultrasonic vibration;

S102: pre-pressing the mixed liquid into a workblank and calendaring it into a slice;

S103: two-way stretching, pre-shaping and coiling the slice.

In the method for fabricating the multifunctional fabric provided above, the fabric fabricated by adding an inorganic nano luminescent material in the PTFE material can absorb UV rays to emit light so as to enhance aesthetic feeling, thereby preventing the UV rays from hurting the human being; moreover, the molecule bond of the inorganic nano luminescent material has a high intensity and is stable, hence, it can overcome the problems of poor firmness and persistence of the PTFE material, so as to enable the fabric to be durable.

Based on the same inventive concept, an embodiment of this disclosure provides an outdoor garment, which is fabricated by using the multifunctional fabric provided above. For the outdoor garment fabricated using the multifunctional fabric provided above, because the PTFE microporous membrane in the multifunctional fabric is added with an inorganic nano luminescent material, the outdoor garment has the characteristics of being breathable and waterproof. The garment can prevent penetration of liquid water effectively, however, gaseous water molecules can pass through freely, such that the sweat released by the human body can easily evaporate through the microporous membrane, thereby keeping the body dry and promoting comfort degree when sports are performed. Meanwhile, the garment also has the characteristics of being windproof, being rainproof, keeping warm and being wear-resistant and so on.

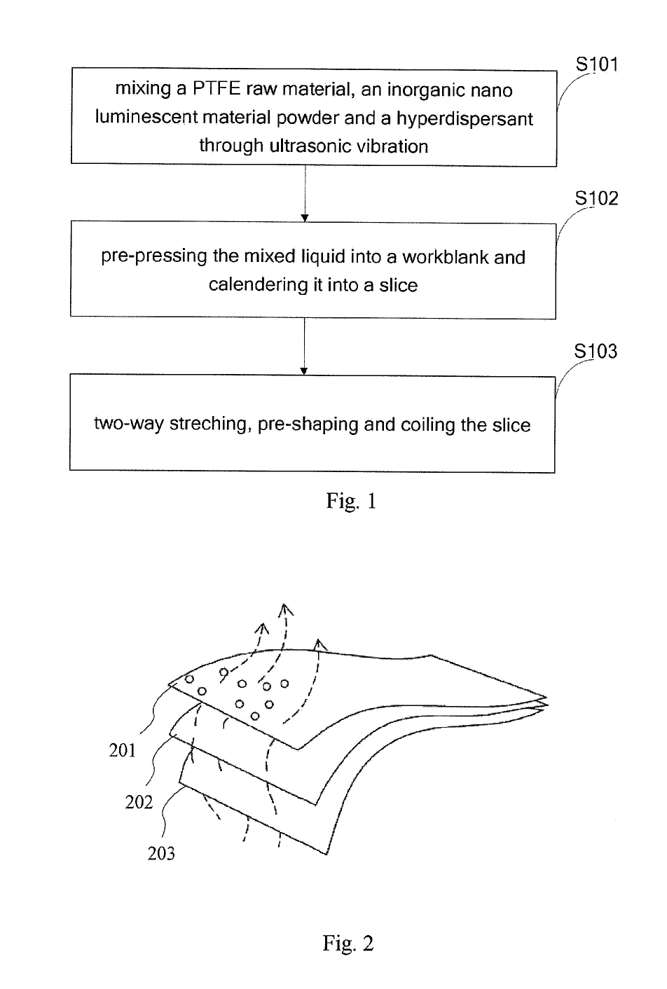

As shown in FIG. 2, the above outdoor garment provided by any of the embodiments of this disclosure comprises: a surface layer 201, a multifunctional layer 202 and an inner layer 203. The surface layer and the multifunctional layer are both fabricated by the multifunctional fabric; and the inner layer is arranged for protecting the surface layer and the multifunctional layer. Specifically, the outdoor garment can use the multifunctional fabric to fabricate the surface layer and the multifunctional layer, which can absorb UV rays to emit light, thereby enabling the outdoor garment not only to be pleasing to the eyes but also to avoid the UV rays from hurting the human being. Meanwhile, the multifunctional layer of the microporous structure enables the outdoor garment to have the characteristics of being breathable, being windproof, being rainproof, keeping warm and to be durable. In addition, an inner layer is added to protect the multifunctional layer and the surface layer, which can further increase the life time of the outdoor garment.

To sum up, embodiments of this disclosure provide a multifunctional fabric, a fabricating method thereof and an outdoor garment. The multifunctional fabric comprises: a PTFE microporous membrane; wherein the PTFE microporous membrane is added with an inorganic nano luminescent material. In this way, after the fabric is made into garments, particularly when it is applied in outdoor sports garments, the inorganic nano luminescent material can absorb UV rays to make the garments glow, thereby not only improving aesthetics of the garments, but also reducing damage of the UV rays to human health. In addition, by adding the inorganic nano luminescent material in the PTFE microporous membrane, the problems of poor firmness and persistence of a single PTFE material can be overcome. Because the molecular bond of the inorganic nano luminescent material has high intensity and is stable, the multifunctional fabric will be durable after it is added with the inorganic nano luminescent material.

Apparently, the skilled person in the art can make various modifications and variations to the embodiments of this disclosure without departing from the spirit and the scope of the present invention. Provided that these modifications and variations of the embodiments belong to the scopes of the claims of the present invention and the equivalent technologies thereof, the present invention also intends to encompass these modifications and variations.

1. A multifunctional fabric, comprising: a PTFE microporous membrane; wherein the PTFE microporous membrane is added with an inorganic nano luminescent material.

2. The multifunctional fabric according to claim 1, wherein the inorganic nano luminescent material is selected from the group consisting of a red powder material, a green powder material, a blue powder material and combinations thereof.

3. The multifunctional fabric according to claim 2, wherein the red powder material is Y₂O₃:Eu.

4. The multifunctional fabric according to claim 2, wherein the green powder material is CeMgAl₁₁O₁₉:Tb.

5. The multifunctional fabric according to claim 2, wherein the blue powder material is BaMgAl₁₀O₁₇:Eu.

6. The multifunctional fabric according to claim 1, wherein the diameter of a micropore of the PTFE microporous membrane is 0.1-0.5 microns.

7. A method for fabricating the multifunctional fabric comprising the steps of:
mixing a PTFE raw material, an inorganic nano luminescent material powder and a hyperdispersant through ultrasonic vibration;
pre-pressing the mixed liquid into a workblank and calendaring it into a slice;
two-way stretching, pre-shaping and coiling the slice.

8. The method according to claim 7, wherein the inorganic nano luminescent material is from the group consisting of a red powder material, a green powder material, a blue powder material and combinations thereof.

9. The method according to claim 8, wherein the red powder material is Y₂O₃:EU.

10. The method according to claim 8, wherein the green powder material is CeMgAl₁₁O₁₉:Tb.

11. The method according to claim 8, wherein the blue powder material is BaMgAl₁₀O₁₇:Eu.

12. The method according to claim 7, wherein the diameter of a micropore of the PTFE microporous membrane is 0.1-0.5 microns.

13. An outdoor garment comprising a multifunctional fabric having a PTFE microporous membrane; wherein the PTFE microporous membrane is added with an inorganic nano luminescent material.

14. The outdoor garment according to claim 13, further comprising: a surface layer, a multifunctional layer and an inner layer; wherein,
the surface layer and the multifunctional layer are fabricated using the multifunctional fabric;
the inner layer is arranged for protecting the surface layer and the multifunctional layer.

15. The outdoor garment according to claim 13, wherein the inorganic nano luminescent material is selected from the group consisting of a red powder material, a green powder material, a blue powder material and combinations thereof.

16. The outdoor garment according to claim 15, wherein the red powder material is Y₂O₃:Eu.

17. The outdoor garment according to claim 15, wherein the green powder material is CeMgAl₁₁O₁₉:Tb.

18. The outdoor garment according to claim 15, wherein the blue powder material is BaMgAl₁₀O₁₇:Eu.

19. The outdoor garment according to claim 13, wherein the diameter of a micropore of the PTFE microporous membrane is 0.1-0.5 microns.
